(19) United States
(12) Patent Application Publication
(10) Pub. No.: US 2010/0062224 A1
(43) Pub. Date: Mar. 11, 2010

(54) METHOD FOR MANUFACTURING A MICROMACHINED DEVICE

(75) Inventors: Ann Witvrouw, Herent (BE); Luc Haspeslagh, Lubbeek-Linden (BE)

Correspondence Address: MCDONNELL BOEHNEN HULBERT & BERGHOFF LLP, 300 S. WACKER DRIVE, 32ND FLOOR, CHICAGO, IL, 60606, US

(73) Assignees: INTERUNIVERSITAIR MICROELEKTRONICA CENTRUM, Leuven (BE); ASML NETHERLANDS BV, Veldhoven (NL)

(21) Appl. No.: 12/447,574

(22) PCT Filed: Oct. 31, 2007
(86) PCT No.: PCT/EP07/61731

§ 371 Date: Apr. 28, 2009

Related U.S. Application Data
(60) Provisional application No. 60/863,679, filed on Oct. 31, 2006.

(30) Foreign Application Priority Data
Oct. 26, 2007 (EP) PCT/EP2007/061558

(51) Int. Cl. B32B 3/00; B32B 38/10; H01B 13/00; C25F 3/02

(52) U.S. Cl. 428/172; 156/247; 216/13

(57) ABSTRACT

The present invention provides a method for manufacturing micromachined devices on a substrate (10) comprising electrical circuitry, the micromachined devices comprising at least one micromachined structure, without affecting the underlying electrical circuitry. The method comprises providing a protection layer (15) on the substrate (10); providing on the protection layer (15) a plurality of patterned layers for forming the at least one micromachined structure, the plurality of patterned layers comprising at least one sacrificial layer (18); and thereafter removing at least a portion of the sacrificial layer (18) to release the at least one micromachined structure. The method furthermore comprises, before providing the protection layer (15), annealing the substrate (10) at a temperature higher than a highest temperature used during manufacturing of the micromachined device, annealing being for preventing gas formation underneath the protection layer (15) during subsequent manufacturing steps. The present invention also provides a micromachined device obtained by the method according to embodiments of the present invention.

### TECHNICAL FIELD OF THE INVENTION

The present invention relates to micromachined devices, e.g. MEMS (micro-electromechanical system) devices. More specifically, the present invention relates to a method for manufacturing a micromachined, e.g. MEMS, device comprising at least one micromachined, e.g. MEMS, structure on a substrate comprising electronic circuitry, e.g. on a substrate comprising CMOS circuitry and to micromachined, e.g. MEMS, devices thus obtained. The method allows forming a micromachined device on a substrate comprising electronic circuitry, e.g. CMOS circuitry, without affecting the underlying circuitry, e.g. CMOS circuitry.

### BACKGROUND OF THE INVENTION

Micro-electromechanical systems (MEMS) such as for example accelerometers, gyroscopes and inkjet print heads are increasingly being used. The future trend is heading towards smaller systems with increased performance. A way to achieve both smaller systems and increased performance may be monolithic integration of MEMS devices on a CMOS substrate comprising the driving, controlling and signal processing electronics. This can improve the MEMS performance by reducing, for example, parasitics in capacitive sensing. Moreover this approach leads to a very compact integration solution, which allows smaller packages.

Obtaining monolithic integration of MEMS devices and embedded electronics is not straightforward because different materials and processing techniques have to be combined on a same substrate. Currently there are three approaches to achieve monolithic integration of MEMS and embedded electronics: (1) first processing MEMS devices and then providing the integrated circuits e.g. next to the MEMS devices; (2) mixing fabrication of both MEMS devices and integrated circuits; and (3) first processing the integrated circuits and then manufacturing the MEMS devices e.g. on top of the integrated circuitry (also referred to as post-processing).

The third approach offers a possibility to process and interconnect devices in a modular manner above any underlying signal processing circuitry without the need for deeper knowledge of the underlying circuit technology. Post-processing however imposes very stringent requirements towards the allowed MEMS processes and materials. In order to avoid any damage to the underlying circuitry and/or degradation of the performance of the underlying circuitry, the MEMS fabrication temperature should be kept below 450° C. and a restriction on the chemicals that can be used during MEMS processing should be kept in mind. Poly silicon germanium (poly SiGe), for example, may be an attractive material for MEMS post-processing. Poly SiGe is a semiconductor alloy material which has properties similar to poly Si but can be processed at substantially lower temperatures than required for poly Si. Hence, poly SiGe may allow manufacturing MEMS devices with desired electrical and mechanical properties at a suitable temperature. In state-of-the-art solutions for protecting underlying CMOS circuitry against chemicals used in MEMS post-processing, protection layers are used or the use of chemicals that affect the CMOS circuits is avoided.

In U.S. Pat. No. 6,210,988 methods are described for forming MEMS structures on top of a substrate comprising electrical circuitry, wherein a ground plane layer and a structural layer of the MEMS devices are formed by SiGe layers. In one embodiment, a SiGe layer with a high Ge content or a pure Ge layer is used as a sacrificial layer in the manufacturing process of the MEMS structure. This type of sacrificial layer can be removed with chemicals such as e.g. hydrogen peroxide which do not affect the underlying electrical circuitry. In another embodiment of U.S. Pat. No. 6,210,988, silicon oxide is used as a sacrificial layer. In order to protect the electrical circuitry underlying the MEMS device from being attacked by HF during release of the MEMS structure, a protection layer is deposited before depositing the sacrificial layer. As indicated in this document, amorphous Si is found to be a useful material for this protection layer.

In U.S. Pat. No. 6,917,459 a method is described for forming MEMS devices on top of a substrate comprising electrical circuitry. According to this method a dielectric layer is deposited on the substrate, this dielectric layer is planarized to create a substantially flat surface and a protective layer is formed after planarizing the dielectric layer. The protective layer is formed of a material which is resistant to etchants used for subsequent MEMS processing, such as for example silicon carbide.

However, in the above-described methods, defects may be formed in the protection layer when forming the protection layer, by copying defects present in underlying layers, e.g. as a result of gas formation underneath the protection layer during manufacturing of the MEMS device or as a result of processes used during MEMS manufacturing, such as for example deposition of MEMS layers and/or etching processes for patterning these layers. Such defects present in the protective layer may still cause etchants to penetrate through the protective layer and cause damage to the underlying electronic circuitry, e.g. CMOS circuitry.

### SUMMARY OF THE INVENTION

It is an object of embodiments of the present invention to provide a method for forming a micromachined device on a substrate comprising electrical circuitry and a micromachined device thus obtained.

In a first aspect, the present invention provides a method for manufacturing a micromachined device, e.g. micro-electromechanical system

(MEMS) device, on a substrate comprising electrical circuitry, e.g. CMOS circuitry, the micromachined, e.g. MEMS, device comprising at least one micromachined, e.g. MEMS structure. The method comprises:
providing a protection layer on the substrate;
providing on the protection layer a plurality of patterned layers for forming the at least one micromachined, e.g. MEMS, structure, the plurality of patterned layers comprising at least one sacrificial layer; and
thereafter removing at least a portion of the sacrificial layer to release the at least one micromachined, e.g. MEMS structure.

The method furthermore comprises, before providing the protection layer, annealing the substrate at a temperature higher than a highest temperature used during manufacturing of the micromachined, e.g. MEMS device, annealing being for preventing gas formation underneath the protection layer during subsequent manufacturing steps.

Annealing the substrate at a temperature higher than a highest temperature used during manufacturing of the micromachined device prevents damage to the protection layer which may be caused by gas formation from underlying layers during steps in the manufacturing process which require heating of the substrate.

The method according to embodiments of the present invention provides good protection of underlying circuitry during manufacturing of the micromachined device. This is done by making sure that the number of defects in the protection layer is kept low, thereby avoiding problems such as e.g. penetration of chemicals through the protection layer.

The protection layer may, for example, comprise SiC. According to other embodiments of the present invention, also any other suitable material may be used for forming the protection layer.

It is an advantage of a method according to embodiments of the present invention that it can be used with cheap and standard materials, such as e.g. silicon oxide (SiO₂), which can easily be planarized and which can be removed by a standard method such as e.g. a stiction-free Vapor HF release, contrary to e.g. Ge sacrificial layers.

The method according to embodiments of the present invention may furthermore comprise, before providing the protection layer, providing on the substrate a dielectric top layer, e.g. a substantially planar dielectric top layer with a number of defects less than 1/cm², for example less than 0.1/cm² or less than 0.01/cm².

According to embodiments of the invention, providing a dielectric top layer, e.g. substantially planar dielectric top layer may comprise:
providing on the substrate a dielectric layer,
planarizing the dielectric layer, and
annealing the substrate to reduce the number of defects in the dielectric layer to less than 1/cm², for example less than 0.1/cm² or less than 0.01/cm².

According to other embodiments of the invention, providing a dielectric top layer, e.g. a substantially planar dielectric top layer, may comprise:
providing on the substrate a first dielectric layer,
planarizing the first dielectric layer, and
providing on the first dielectric layer a second dielectric layer with a deposition technique not copying defects or topography from an underlying layer, thereby forming a dielectric layer comprising a number of defects less than 1/cm², for example less than 0.1/cm² or less than 0.01/cm².

Providing the second dielectric layer may, for example, be performed by High Density Plasma Chemical Vapor Deposition.

Annealing the substrate for preventing gas formation underneath the protection layer during subsequent manufacturing steps may be performed at a temperature between 1° C. and 10° C. higher than the highest temperature used during manufacturing of the micromachined, e.g. MEMS, device. The highest temperature used during manufacturing of the micromachined, e.g. MEMS, device may, according to embodiments of the present invention, be 450° C. According to other embodiments, the highest temperature used during manufacturing of the micromachined, e.g. MEMS, device may be less than 450° C. or less than 400° C.

According to embodiments of the present invention, providing a protection layer on the substrate may be performed by providing a substantially planar protection layer.

According to embodiments of the invention, materials and process parameters of steps of the manufacturing process of the micro-machined, e.g. MEMS, devices may be selected such that they do not affect the high quality of the protection layer. With high quality is meant that the protection layer has a low defect density and shows a low impermeability to chemicals used during the manufacturing process. In other words, the materials and process parameters of the manufacturing process of the micromachined, e.g. MEMS, device may be selected such that during and after manufacturing of the micromachined, e.g. MEMS, device the protection layer has a number of defects less than 1/cm², for example less than 0.1/cm² or less than 0.01/cm2, such that the protection layer protects the substrate and, more important, the electrical circuitry on the substrate against influence of further processing steps, e.g. processing steps for forming the plurality of patterned layers and against effects of processing steps for removing at least a portion of the sacrificial layer. According to embodiments of the invention, in order to obtain a protection layer of high quality, the protection layer may be made planar and the number of defects in the protection layer may be reduced. More in particular, the number of defects extending through the protection layer, such as e.g. pinholes, micro cracks or density variations, may be reduced to substantially zero. Elimination or at least reduction of defects extending through the protection layer may avoid penetration of chemicals used during post-processing (e.g. MEMS sacrificial layer etching) through the protection layer, such that a good protection of the underlying electrical circuitry may be obtained.

According to embodiments of the invention, process parameters may for example be materials used, deposition methods used for providing different layers, deposition temperatures and/or deposition pressures used during deposition of the different layers, deposition powers, etch techniques and/or etch chemistries.

Providing a plurality of patterned layers on the protection layer may, amongst others, comprise depositing a layer of electrode material for forming at least one electrode. Forming at least one electrode may be performed by patterning, e.g. etching the layer of electrode material.

The layer of electrode material may, for example, comprise Si₁₋ₓGeₓ with 0.5<x<0.65. The layer of electrode material may, for example, be deposited by plasma enhanced Chemical Vapor Deposition or plasma assisted Chemical Vapor Deposition.

Depositing the layer of electrode material may be performed at a deposition temperature, deposition pressure and deposition power at which stress in the layer of electrode material is minimised. With the stress in the layer of electrode material being minimised is meant that the stress in the layer of electrode material is less than 100 MPa, for example less than 50 MPa or less than 10 MPa. The stress in the layer of electrode material may be a tensile stress and may be referred to as residual tensile stress.

Etching the layer of electrode material may, for example, be performed by using a HBr based Reactive Ion Etching process.

According to embodiments of the present invention the electrical circuitry may comprise at least one electrical contact pad. The method of the present invention may, according to these embodiments, furthermore comprise, after forming the protection layer and before forming the plurality of patterned layers, providing at least one electrically conductive structure at locations where an electrical contact pad of the underlying electrical circuitry is located.

Providing at least one electrically conductive structure may comprise:
forming at least one via extending from at least one of the at least one electrical contact pad through the protection layer,
filling the at least one via with an electrically conductive material, and
performing a planarization step.

According to embodiments of the present invention, at least one electrically conductive structure may form an electrical connection between an electrical contact pad and an electrode of the micromachined, e.g. MEMS, device.

These electrical connections may be used both for electrically connecting the underlying electrical circuitry with electrodes of the micromachined device, e.g. MEMS electrodes, and for electrically connecting the underlying electrical circuitry with the outside world (bond pads).

According to embodiments of the present invention, by forming electrical connections through the protection layer before processing the micromachined, e.g. MEMS, device, the need for etching through the protection layer after MEMS processing may be avoided.

After forming the plurality of patterned layers and before at least partially removing the sacrificial layer, the method may furthermore comprise:
providing, e.g. etching at least one opening through the sacrificial layer at a location where an electrically conductive structure is located, and
providing in the at least one opening an electrically conductive layer thereby forming at least one bond pad.

The electrically conductive layer may, for example, comprise Al and/or TaN. According to other embodiments, the electrically conductive layer may comprise any other suitable material known by a person skilled in the art. According to embodiments of the present invention, at least one of the at least one electrically conductive structure may form an electrical connection between an electrical contact pad and a bond pad.

In a second aspect, the present invention provides a micromachined device obtained by means of a manufacturing method in accordance with embodiments of the present invention.

In a third aspect, the present invention provides a micromachined device on a substrate comprising electrical circuitry, the micromachined device comprising at least one micromachined structure and comprising, in between the electrical circuitry and the at least one micromachined structure, a protection layer with a defect density of less than 1/cm², for example less than 0.1/cm² or less than 0.01/cm².

According to embodiment of the invention, the micromachined device may furthermore comprise, in between the electrical circuitry and the protection layer a dielectric layer with a defect density of less than 1/cm², for example less than 0.1/cm² or less than 0.01/cm².

Particular and preferred aspects of the invention can be found in the independent and dependent claims. Features from the dependent claims may be combined with features of the independent claims and with features of other dependent claims.

The characteristics, features, and advantages of the invention will be clarified in the detailed description in combination with the drawings, which illustrate the principles of the invention. This description is given as an example only, without limiting the scope of the invention.

### BRIEF DESCRIPTION OF THE DRAWINGS

FIGS. 1 to 9 illustrate subsequent steps in a method for manufacturing a micromachined device according to an embodiment of the present invention.

FIG. 10 is a schematic representation of a sample used for experiments with different electrode materials.

FIG. 11 is a SEM picture of a wafer with a 800 nm thick oxide layer and a 300 nm thick SiC layer covering a small step after etching with Vapor HF.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, underneath and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may do so. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

The term “substrate” used in the description and the claims may include any underlying material or materials that may be used, or contain, or upon which a device such as a MEMS device, a mechanical, electronic, electrical, pneumatic, fluidic or semiconductor component or similar, a circuit or an epitaxial layer can be formed. In various embodiments of the invention the substrate may include a semiconductor substrate such as, for example, a doped silicon substrate, a gallium arsenide (GaAs) substrate, a gallium arsenide phosphide (GaAsP) substrate, an indium phosphide (InP) substrate, a germanium (Ge) substrate or a silicon germanium (SiGe) substrate. The substrate may include, for example, an insulating layer such as a silicon oxide layer or a silicon nitride layer in addition to a semiconductor substrate portion. Thus the term “substrate” also encompasses substrates such as silicon-on-glass and silicon-on-sapphire substrates. The term “substrate” is thus used to define generally the elements for layers that underlie a layer or portions of interest. The substrate may be any other base on which a layer is formed, for example a glass substrate or a glass or metal layer. In the following, processing will primarily be described with reference to processing silicon substrates, but the skilled person will appreciate that the preferred embodiments can be implemented based on materials such as other semiconductor material systems, glass or polymeric materials and that the suitable materials as equivalents can be selected by a skilled person.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

The present invention relates to monolithic integration of micromachined devices, e.g. MEMS devices, on substrates comprising electrical circuitry, such as e.g. CMOS circuitry, by post-processing and to micromachined, e.g. MEMS, devices thus obtained.

With ‘post-processing’ is meant that the micromachined devices, e.g. MEMS devices, are formed on the substrate after the electrical circuitry has been provided. In other words, the micromachined devices, e.g. MEMS devices, are formed on the substrate while the electrical circuitry is already present. Therefore, care is to be taken that the electrical circuitry is not affected, damaged and/or destroyed during processing of the micromachined device, e.g. MEMS device.

Post-processing imposes stringent requirements towards allowed techniques and used materials for forming the micromachined devices, e.g. MEMS devices. In order to avoid any damage or degradation in the performance of the electrical circuitry on the substrate, the maximum temperature used during manufacturing of the micromachined, e.g. MEMS, devices may be limited for example to 450° C. or less, for example less than 400° C. Furthermore, there is a restriction on the chemicals that can be used during the manufacturing process, e.g. during etching away of a sacrificial layer used to form micromachined, e.g. MEMS structures.

The present invention therefore provides a method for manufacturing a micromachined, e.g. MEMS, device on a substrate comprising electrical circuitry, the micromachined, e.g. MEMS, device comprising at least one micromachined, e.g. MEMS, structure. The method comprises:
providing a protection layer on the substrate with the electrical circuitry,
providing on the protection layer a plurality of patterned layers for forming the at least one micromachined structure, the plurality of patterned layers comprising at least one sacrificial layer, and
thereafter removing at least a portion of the sacrificial layer to release the at least one micromachined structure.

The method furthermore comprises, before providing the protection layer, annealing the substrate at a temperature higher than a highest temperature that will be used during manufacturing of the micromachined device, annealing being for preventing gas formation underneath the protection layer during subsequent manufacturing steps.

The method according to embodiments of the invention allows forming micromachined, e.g. MEMS, devices on a substrate comprising electronic circuitry without affecting the underlying electrical circuitry, e.g. without damaging or degrading the performance of the electrical circuitry present on the substrate.

According to embodiments of the present invention, during manufacturing of the micromachined device the underlying electrical circuitry is protected by means of a protection layer, which may, for example, comprise SiC. By, before providing this protection layer, first annealing the substrate at a temperature higher than the highest temperature used in the steps of manufacturing the micromachined device, the substrate and any layer present on the substrate before providing the protection layer may be outgassed. With ‘outgassed’ is meant that occluded gasses are removed from the substrate and any layer present on the substrate before providing the protection layer by heating the substrate. This prevents gas formation during further manufacturing of the micromachined device after having provided the protection layer because gas formation may cause defects to be formed in the protection layer. Hence, with the method according to embodiments of the invention, this gas formation, and thus defect formation in the protection layer may be avoided such that a protection layer with a low defect density, e.g. a defect density of less than 1/cm², for example less than 0.1/cm² or less than 0.01/cm² may be obtained. This prevents penetration of chemicals used during post-processing through the protection layer and thus avoids damaging of the underlying electronic circuitry, e.g. CMOS circuitry. It is thus an advantage of embodiments of the present invention that a protection layer can be obtained with a high quality and a low defect density, and that this high quality and low defect density may be maintained during post-processing. With high quality is meant that the protection layer provides good protection to the electrical circuitry on the substrate on which the micromachined devices are formed, the protection being against for example chemicals used during the manufacturing process of these micromachined, e.g. MEMS, devices. With low defect density is meant that the number of defects extending through the protection layer, such as e.g. pinholes, micro cracks or density variations, is reduced to substantially zero, e.g. to less than 1/cm², for example less than 0.1/cm² or less than 0.01/cm².

Another advantage of the method according to embodiments of the present invention is that it provides a compact integration solution and it enables integrating micromachined, e.g. MEMS, devices without introducing changes in the fabrication process of the electrical circuitry, e.g. CMOS circuitry, on the substrate.

Hereinafter, subsequent steps in the method according to embodiments of the present invention will be described. It has to be understood that this description is only by way of an example and that the processing steps and the sequence of processing steps described hereinafter are not intended to limit the invention in any way. Furthermore, the method will be described by means of the electrical circuitry being CMOS circuitry. This is only for the ease of explanation and is also not intended to limit the invention in any way. According to other embodiments of the invention, the electrical circuitry may be any other electrical circuitry that can be combined with micromachined devices. Moreover, the method will be described by means of the micromachined devices being MEMS devices comprising at least one MEMS structure. Again, this is only for the ease of explanation and is not intended to limit the invention in any way. The micromachined device may be any micromachined device requiring a sacrificial layer for manufacturing it.

Examples of MEMS devices that can be manufactured with the method according to embodiments of the present invention are e.g. micro-mirrors, accelerometers, gyroscopes, inkjet printheads and actuators. The electrical circuitry on the substrate underneath the MEMS devices may for example be driving circuitry for the MEMS devices.

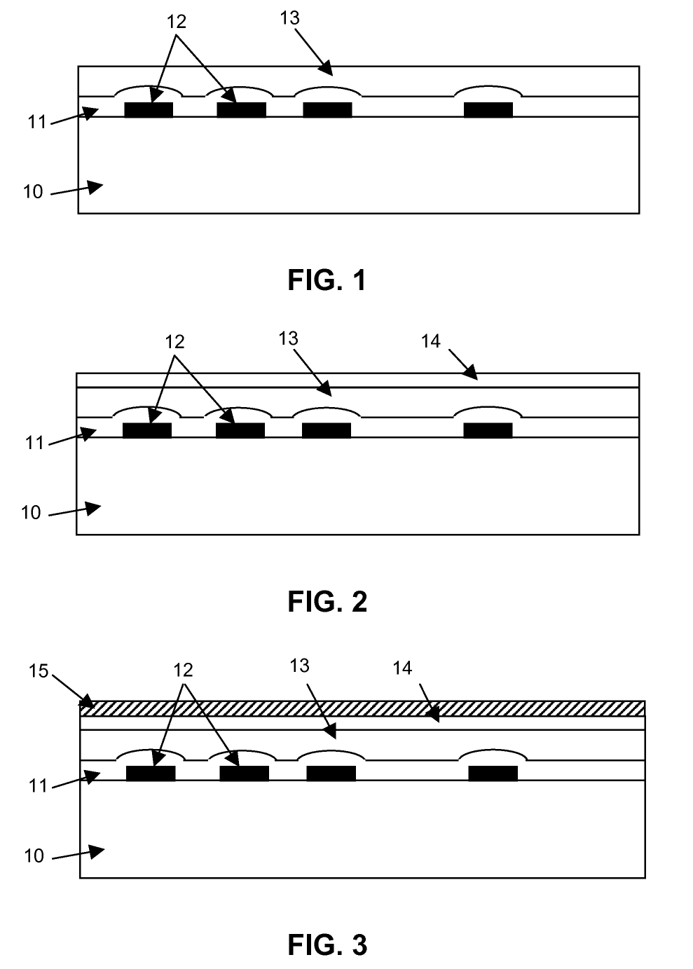

A sequence of steps for MEMS post-processing on a CMOS substrate 10 according to an embodiment of the present invention is illustrated in FIG. 1 to FIG. 9. A substrate 10 comprising CMOS circuitry on a major surface is provided. The CMOS circuitry may comprise at least one electrical contact pad 12 that may be formed by any suitable method and that may comprise any suitable conductive material known by a person skilled in the art, such as for example Al, Cu, Ti, TiN, Ta, TaN or combinations thereof. After deposition of a standard CMOS passivation layer 11 on the substrate 10 comprising the CMOS circuitry as known by a person skilled in the art, a first dielectric layer 13 may be deposited over the standard CMOS passivation layer 11, for example by means of Chemical Vapor Deposition (CVD), Plasma Enhanced or Plasma Assisted CVD (PECVD/PACVD) or High Density Plasma (HDP) CVD. The first dielectric layer 13 may then be planarized, for example by Chemical Mechanical Polishing (CMP). The first dielectric layer 13 may, according to embodiments of the invention, be a silicon dioxide layer or a silicon nitride layer. However, according to other embodiments any other suitable dielectric material may be used for forming the first dielectric layer 13. After planarization, e.g. planarization by means of CMP, and cleaning, e.g. post-CMP cleaning, the first dielectric layer 13 may comprise a number of defects, partly induced by the planarization step. For example, there may be contamination left after post-CMP cleaning or a gas or a liquid may be entrapped or occluded in the planarized first dielectric layer 13. The structure obtained after performing the previous described steps is illustrated in FIG. 1.

According to embodiments of the present invention, the method may in a next step comprise providing a substantially planar dielectric top layer 14 with a low defect density, e.g. a top layer with a number of defects less than 1/cm², for example less than 0.1/cm² or less than 0.01/cm². Providing a dielectric top layer 14 with a low defect density may be performed in different ways.

One way to obtain a dielectric top layer 14 with a low defect density may be by providing a substantially planar dielectric layer 13 on the substrate 10, for example by means any suitable deposition technique followed by planarization by means of CMP, and performing an annealing step. Annealing may reduce the defects in the first dielectric layer 13, for example the defects that have been introduced by the CMP planarization step, e.g. defects due to organic or inorganic contamination or defects related to entrapped gas or liquid to less than 1/cm², for example less than 0.1/cm² or less than 0.01/cm². According to embodiments of the present invention, the annealing step may be performed at a temperature that is a few ° C. higher, for example 1° C. to 10° C. higher, e.g. 5° C. higher, than the highest processing temperature that will be used during post-processing, and thus may coincide with the annealing step for outgassing the substrate 10. For example, if the highest post-processing temperature will be 450° C., annealing may be done at, for example, 455° C. Hence, according to these embodiments, the annealing step has, besides defect reduction in the dielectric layer 13, also the additional effect of outgassing the material of the substrate 10 and of any layer present on the substrate 10. However, according to other embodiments of the invention, annealing the substrate 10 for reducing the number of defects in the dielectric layer 13 and annealing the substrate 10 for outgassing the material of the substrate and of any layer present on the substrate 10 may be performed in different steps.

A second way to obtain a dielectric top layer 14 with a low defect density may be by depositing a second dielectric layer 14 onto the first planarized dielectric layer 13 with an appropriate deposition technique, e.g. with a deposition technique that does not copy defects or topography from the underlying layer, such as for example HDP CVD (High Density Plasma Chemical Vapor Deposition) or spin-on. The second dielectric layer 14 may for example be a HDP (high deposition temperature) silicon oxide, HDP silicon nitride or spin-on glass. By selecting an appropriate deposition technique, e.g. a deposition technique not copying defects from the underlying layer, a second dielectric layer 14 with a low number of defects, e.g. a number of defects of less than 1/cm², for example less than 0.1/cm² or less than 0.01/cm², may be obtained.

Yet another way to obtain a dielectric top layer 14 with a low defect density may be by combining the first way and the second way, e.g. by performing at least one annealing step and in addition depositing a second dielectric layer 14 on top of the first dielectric layer 13 with an appropriate deposition technique as described above.

According to the example given in the FIGS. 1 and 2, first a first dielectric layer 13 may be provided onto the substrate 10 (see FIG. 1). Optionally the first dielectric layer 13 may be annealed to reduce the number of defects present in that layer 13. Next a second dielectric layer 14 may then be deposited (see FIG. 2) with a deposition technique that does not copy defects from an underlying layer, e.g. from the first dielectric layer 13.

The importance of obtaining a substantially planar dielectric top layer 14 with a low defect density according to embodiments of the invention is that when in a subsequent step a protection layer 15 is formed (see FIG. 3), which may take over defects and/or topography from the underlying layer, the number of defects in the protection layer will also be low, e.g. less than 1/cm², for example less than 0.1/cm² or less than 0.01/cm². Thus, the presence of a substantially planar dielectric top layer 14 with a low defect density may allow providing a substantially planar protection layer 15 with a low defect density, e.g. with a number of defects less than 1/cm², for example less than 0.1/cm² or less than 0.01/cm², even with a deposition technique that copies and/or amplifies defects and/or topography from the underlying layer. More in particular, the number of defects extending through the protection layer 15, such as e.g. pinholes, micro cracks or density variations, may be reduced to substantially zero, e.g. to less than 1/cm², for example less than 0.1/cm² or less than 0.01/cm². According to embodiments of the invention, the protection layer 15 may, for example, be a SiC layer and may, for example, be deposited by means of PECVD (Plasma Enhanced CVD) or PACVD (Plasma Assisted CVD), known as standard deposition techniques for SiC at CMOS compatible temperatures, e.g. at temperatures lower than 450° C., for example lower than 400° C. Such SiC layer deposited by PECVD or PACVD copies defects present in an underlying layer and does not planarise out topography present in the underlying layer. The SiC layer deposited in that way may thus have defects copied from the underlying layer or it may have defects, e.g. holes or cracks if formed on top of remaining topography of the underlying layer. Therefore, as described above, when using techniques which copy defects of an underlying layer, there may be a need for providing a substantially planar top layer 14 with a low defect density before providing the protection layer 15 as described above.

According to other embodiments of the invention, however, the provision of a planar dielectric top layer 14 with low defect density may be omitted. In that case, for providing a protection layer 15 with a low number of defects, e.g. with a number of defects of less than 1/cm², for example less than 0.1/cm² or less than 0.01/cm², a deposition technique may be used which does not copy defects from the underlying layer, in the embodiments given the underlying standard CMOS passivation layer. In that way, a protection layer 15 with a low defect density may be obtained.

Before depositing the protection layer 15 the substrate 10 is annealed at a temperature higher than a highest temperature that will be used during manufacturing of the MEMS device. This is done for preventing gas formation underneath the protection layer 15 during subsequent manufacturing steps. In other words, the annealing step may be for outgassing the material of the substrate 10 and of any layer present on the substrate 10 before providing the protection layer 15. According to embodiments of the invention, in case a second dielectric layer 14 is provided, the annealing step may be performed on the substrate 10 comprising the electrical circuitry, a standard CMOS passivation layer 11, the first planarized dielectric layer 13 and the second dielectric layer 14. According to other embodiments of the invention, where no second dielectric layer 14 is provided in between the first planarized dielectric layer 13 and the protection layer 15, the annealing step may also be for reducing the number of defects in that dielectric layer 13. The annealing step may be performed during a suitable time period, for example a time period of at least 20 minutes, at a temperature higher than the highest temperature that will be used during post-processing, e.g. a temperature of 455° C., in an inert atmosphere, e.g. in a forming gas (N₂/H₂) atmosphere. According to still further embodiments, where no dielectric layer is provided before the protection layer 15 is provided, annealing may be performed on the substrate 10 comprising the electrical circuitry and the standard CMOS passivation layer 11.

The reason for selecting an annealing temperature slightly higher, e.g. between 1° C. and 10° C. higher than the highest post-processing temperature during the manufacturing process is to avoid gas formation underneath the protection layer 15 during post-processing. Gas formation underneath the protection layer 15 has to be avoided because this could cause damage to the protection layer 15 such that e.g. chemicals used during post-processing may penetrate through the damaged protection layer 15 and affect, damage and/or deteriorate the underlying electrical circuitry.

A number of experiments were performed to study the effect of the quality of, e.g. the presence and number of defects in the dielectric top layer 14 on the integrity of a SiC protection layer 15. One experiment was performed on silicon wafers with a planar 800 nm thick oxide layer as the dielectric top layer 14 and a 300 nm thick PECVD SiC layer as a protection layer 15 on top of the dielectric top layer 14. In the experiment, a first wafer was used with a 300 nm SiC layer and without CMP treatment of the underlying oxide layer, i.e. the oxide layer on the reference wafer was not planarized by means of CMP before the SiC layer was deposited. The wafer did not show any degradation of the underlying oxide layer after Vapor HF etching. On a second wafer a 300 nm SiC layer was grown without CMP treatment of the underlying oxide layer, but with a CMP planarization step after SiC deposition. This wafer also showed no degradation after Vapor HF etching. For a third wafer a standard oxide CMP planarization was done before SiC deposition. For this wafer there was a clear attack of the underlying oxide layer, even after 20 minutes of Vapor HF etching at 35° C. Degradation of this wafer was also seen after 1 minute of wet HF (49%) etching. This indicates that in this case the SiC layer 15 is not sufficiently defect-free to avoid penetration of chemicals through the layer 15. This is because planarizing the underlying oxide layer 14 by means of CMP may leave residues or may introduce defects at the interface between the oxide layer 14 and the protection SiC layer 15, which prevent the growth of a substantially defect-free PECVD SiC protection layer 15, e.g. a SiC protection layer 15 with a defect density of less than 1/cm², for example less than 0.1/cm² or less than 0.01/cm².

The above-described experiment illustrates that, when a dielectric top layer 14 is present underneath the protection layer 15, this dielectric top layer 14 should preferably have a low defect density, e.g. a defect density of less than 1/cm², for example less than 0.1/cm² or less than 0.01/cm², before providing a protection layer 15, e.g. a PECVD SiC protection layer.

Experiments furthermore show that planarization of the underlying dielectric layer 14 is necessary for obtaining a good SiC protection layer 15. It has been shown that a SiC protection layer 15 deposited on a wafer or layer with topography results in insufficient protection if provided with a deposition technique that copies defects from an underlying layer as was described before. For example, experiments have been performed on wafers with a 300 nm thick SiC layer 15 covering a small step 21. SEM pictures (see FIG. 11) show that, after etching with Vapor HF, the oxide layer 14 is attacked (indicated with arrow 22 in FIG. 11) through the SiC layer 15 at the location of the step 21, even though the sidewall coverage of the SiC layer 15 looks good.

Table 1 gives an overview of experiments performed to investigate the protective quality of a PECVD SiC layer 15, for differently treated dielectric layers 14 present under the SiC layer 15. For all wafers, a 800 nm thick dielectric layer 13 was deposited on the substrate 10. The dielectric layer 13 was then annealed at 420° C. and planarized by means of CMP. This annealing step does not correspond to the annealing step in accordance with the present invention. After that, the different samples received different treatments as summarized in table 1. Finally a 300 nm thick PECVD SiC layer 15 was deposited on all samples, followed by an annealing step at 420° C. The quality of the SiC layer 15 was then assessed by performing a vapor HF etching and checking the integrity of the dielectric layer 14 underlying the SiC layer 15.

TABLE 1
Overview of experiments performed to investigate the protective
quality of a PECVD SiC layer.

| | D03 | D04 | D05 | D07 | D09 | D13 |
|---|---|---|---|---|---|---|
| 20 nm DXZ | X | | | | | |
| 200 nm IMD | | X | X | | | |
| HF clean | | | | X | | |
| sinter 420° C. | X | | X | X | X | |
| 300 nm SiC | X | X | X | X | X | X |
| sinter 420° C. | X | X | X | X | X | X |
| 20′ vHF test | bad | | OK | OK | OK | |
| 60′ vHF test | | OK | | OK | OK | Bad |

Reference sample D13, for which SiC deposition was done immediately after oxide CMP, without annealing the substrate 10 for obtaining an oxide layer 14 with a low defect density, clearly shows damage to the dielectric layer 14 underlying the protection layer 15 after 60 minutes of Vapor HF etching.

Protection properties of the SiC layer 15 where found to be satisfactory either after depositing a fresh IMD (Inter Metal Dielectric) oxide 14, which is a high density plasma oxide (sample D04) and does not copy defects from the underlying layer, or after a sintering or annealing step for reducing the defect density to less than 1/cm², for example less 0.1/cm² than or less than 0.01/cm² (samples D07 and D09) or by a combination of an IMD oxide deposition and an annealing step (sample D05). Not all oxide depositions are however helpful. Depositing a 20 nm DXZ oxide (PECVD oxide) does not result in good

SiC protection properties (sample D03), probably because defects are propagated in this layer, which has a bad step coverage. The thickness of the second dielectric layer 14 may for example be in the range between 50 nm and 800 nm, for example in the range between 100 nm and 500 nm, for example between 100 nm and 300 nm.

According to other embodiments of the present invention, and as already described above the protection layer 15, e.g. SiC protection layer may be grown by means of HDP CVD or spin-on. With these techniques there may be no need for providing a substantially planar dielectric top layer 14 with low defect density before providing the protection layer 15. According to these embodiments, before providing the protection layer 15, the substrate 10 is annealed at a temperature higher than the highest temperature used during manufacturing of the micromachined device for preventing gas formation underneath the protection layer during subsequent manufacturing steps.

Other materials than SiC may be used for forming the protection layer 15, such as for example aluminum oxide, polyimide, epoxy, BCB, amorphous silicon, amorphous germanium or amorphous silicon germanium. Deposition may be performed at a temperature in the range between 300° C. and 450° C., e.g. between 300° C. and 400° C., e.g. at 350° C. The protection layer 15 may be thicker than 100 nm, for example in the range between 100 nm and 500 nm, for example 300 nm. The protection layer 15 may have a function of protecting the underlying electrical circuitry, e.g. CMOS circuitry, against influences of e.g. chemicals used during post-processing of the MEMS devices on the substrate comprising the electrical circuitry, e.g. CMOS circuitry. More in particular, the protection layer 15 may protect the underlying circuitry during post-processing steps, e.g. during etching of the sacrificial layer (see further). Therefore, the protection layer 15 may have as little defects as possible, e.g. it may have a number of defects of less than 1/cm², for example less than 0.1/cm² or less than 0.01/cm².

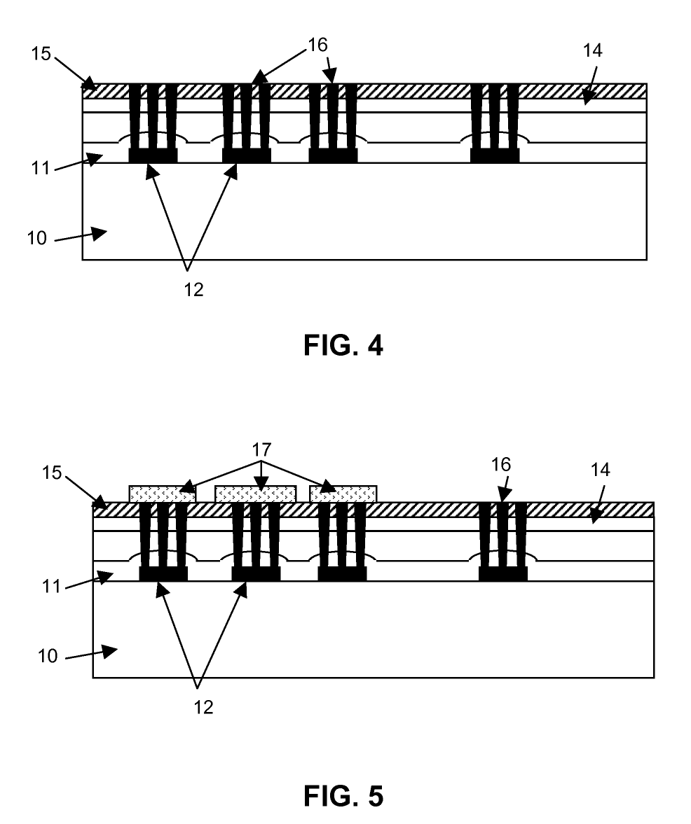

The method according to embodiments of the present invention may furthermore comprise forming electrical connections extending from an electrical contact pad of the underlying CMOS electrical circuitry through the protection layer 15. These electrical connections may be used both for electrically connecting the underlying electrical circuitry with electrodes (see further) of the MEMS device, and for electrically connecting the underlying electrical circuitry with the outside world (bond pads). Therefore, after providing the protection layer 15, in a next step of a method according to embodiments the present invention (illustrated in FIG. 4) vias may be provided, e.g. etched in the stack formed by the dielectric layers 11, 13, 14 and the protection layer 15, e.g. at locations where an electrical contact pad 12 of the underlying electrical circuitry is located. This may be done by any suitable technique known by a person skilled in the art. In case of e.g. a SiC protection layer, the protection layer 15 may for example be locally removed by a method as described in U.S. Pat. No. 6,599,814, the method comprising at least partly converting an exposed part of the SiC layer 15 into an oxide-silicon layer by exposure to an oxygen-containing plasma and removing the oxide-silicon layer, wherein the conversion step and the removal step may be repeated until the underlying dielectric layer 14 is exposed. The SiC layer 15 is not converted into a pure silicon oxide layer, but into a layer comprising at least Si and O, and optionally comprising C and/or N and/or H wherein the C/N/H fraction is smaller than the O fraction. Therefore, the layer formed is referred to here as oxide-silicon layer. Top layers of the CMOS circuitry, for example a TiN layer of a top metal stack (e.g. electrical contact pad) of CMOS structures of the CMOS circuitry, may be used as an etch stop layer during etching of the dielectric layers 11, 13, 14 and the protection layer 15 for forming vias.

In a next step conductive plugs 16 may be deposited in the vias (see FIG. 4), e.g. by means of CVD, PECVD or Physical Vapor Deposition (PVD). This approach allows forming an electrical connection extending from at least one of the CMOS electrical contact pads 12 through the protection layer 15. The conductive plugs 16 may e.g. comprise a metal or a metal stack, e.g. a Ti/TiN/W metal stack, or a doped semiconductor e.g. doped SiGe. For example, in case of Ti/TiN/W plugs, first a thin Ti/TiN via liner may be deposited in the vias, the via liner having a thickness of a few nm to a few tens of nm and acting as a diffusion barrier for preventing diffusion of the via metal (e.g. W) into adjacent layers. After providing the via liner, the vias are filled with via metal (e.g. W) and afterwards a planarization step, e.g. a CMP planarization step, may be performed. At this stage of the process, the surface of the structure may be substantially flat and may be formed by the protection layer 15, e.g. SiC protection layer, and the conductive, e.g. metal plugs 16, for example W plugs (see FIG. 4).

In a next step, a plurality of patterned layers may be provided on the protection layer 15 for forming the at least one MEMS structure. Providing the plurality of patterned layers may be done by any suitable technique known by a person skilled in the art. The plurality of patterned layers may comprise any number of patterned layers and any material necessary for forming the required micromachined structure, in the example given MEMS structure. Deposition techniques, etching techniques and materials used for the plurality of patterned layers may be performed such that they do not bring any additional damage or defects to the protection layer 15. Hence, deposition techniques, etching techniques and materials used for the plurality of patterned layers may be performed such that the number of defects in the protection layer 15 during and after manufacturing of the MEMS device is always less than 1/cm², for example less than 0.1/cm² or less than 0.01/cm².

According to embodiments of the invention, providing a plurality of patterned layers may, amongst others, comprise providing and patterning a layer of electrode material for forming at least one electrode 17 for the MEMS device (see FIG. 5). This layer of electrode material may be deposited on top of the protection layer 15. Patterning the layer of electrode material may, for example, comprise locally etching the layer of electrode material with a good selectivity towards the protection layer 15 and the conductive plugs 16. According to embodiments of the present invention, the electrode material, the technique used for depositing the layer of electrode material and the etch process for patterning the layer of electrode material may be such that they do not introduce defects in the protection layer 15 and they do not attack the conductive plugs 16. According to embodiments of the present invention, the layer of electrode material may comprise Si₁₋ₓGeₓ, with 0.5<x<0.65. However, according to other embodiments of the invention, other materials may also be used, provided that the deposition and patterning of the layer of electrode material does not introduce defects in the underlying protection layer 15.

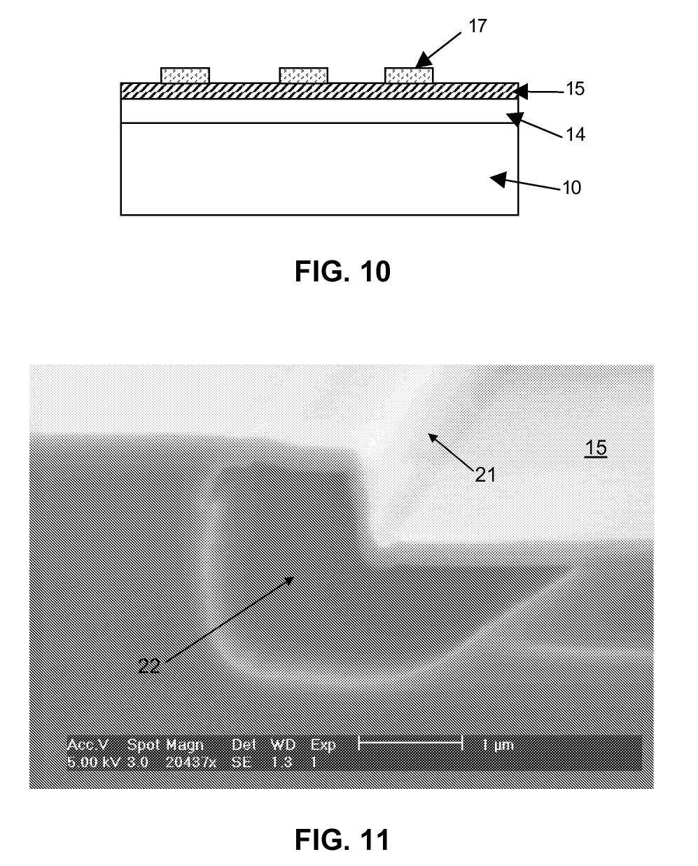

Experiments have been done with different materials for forming at least one MEMS electrode 17. An example of a sample used for these experiments is shown in FIG. 10. On a silicon wafer 10 a silicon oxide layer was deposited, planarized and annealed to form a dielectric top layer 14 with a number of defects less than 1/cm², for example less than 0.1/cm² or less than 0.01/cm². Onto the silicon oxide layer 14 a SiC layer 15 was deposited, followed by deposition and patterning of a layer of electrode material to form at least one electrode 17. In a first sample a 700 nm Al layer was used to form the at least one electrode 17, in a second sample a 100 nm TiN layer was used to form the at least one electrode 17 and in a third sample a 300 nm SiGe layer was used to form the at least one electrode 17. After depositing the layer of electrode material, an etching step was performed for patterning the layer of electrode material. For the sample comprising the 700 nm Al layer and for the sample comprising the 100 nm TiN layer, a BCl₃-based etch chemistry was used. For the sample comprising the SiGe layer, a HBr based etch chemistry was used. In a next step the samples were exposed to Vapor HF etching at 35° C. during 60 minutes in a Pad Fume system of Gemetec with heated wafer stage. It was observed that both with the 700 nm Al stack and the 100 nm TiN electrode, the oxide layer 14 underneath the SiC layer 15 is attacked, resulting in a complete delamination of the SiC layer 15. With the 300 nm SiGe electrode 17, the oxide layer 14 was not attacked, indicating that the SiC layer 15 remains a good protection layer. This difference observed between the samples is because of the etch chemistry used to pattern the layer of electrode material. These results thus illustrate that degradation of the SiC layer 15 as a result of etching the layer of electrode material should be minimized. Formation of defects in the protection layer 15 during etching of the layer of electrode material may be avoided by selecting an appropriate etch chemistry. For example, in case of SiGe electrodes 17, a HBr based etch chemistry may be used.

Furthermore, not only the electrode material but also mechanical properties (e.g. stress) of the layer of electrode material may play a role in avoiding damage to the protection layer 15. For example, mismatches in stress between the layer 17 of electrode material and the protection layer 15 during deposition or during thermal cycling may lead to the creation of defects in the protection layer 15. Mismatches in stress can be a result of the intrinsic material properties or may be related to the deposition technique used. For example, it has been experimentally shown that with a 350 nm thick SiGe electrode 17 formed by depositing a layer of electrode material by means of PECVD and having a residual tensile stress, there was no degradation of the underlying SiC protection layer 15, while with a 350 nm thick SiGe electrode 17 formed by depositing a layer of electrode material by means of CVD and having a residual compressive stress the SiC protection layer 15 clearly degraded. According to an embodiment of the present invention the Si₁₋ₓGₓ layer may be deposited by means of PECVD or PACVD techniques. A Si₁₋ₓGeₓ electrode layer with a low residual tensile stress, e.g. lower than 100 MPa tensile, for example lower than 50 MPa tensile or lower than 10 MPa tensile, may be preferred, rather than a layer of electrode material with a residual compressive stress. Methods for controlling stress in SiGe layers are, for example, described in US 2006-0166467 and in EP 1801067.

In locations where at least one electrode 17 of the MEMS device is in electrical contact with the conductive plugs 16, an electrical connection may be formed between the electrode 17 of the MEMS device and a CMOS electrical contact pad 12.

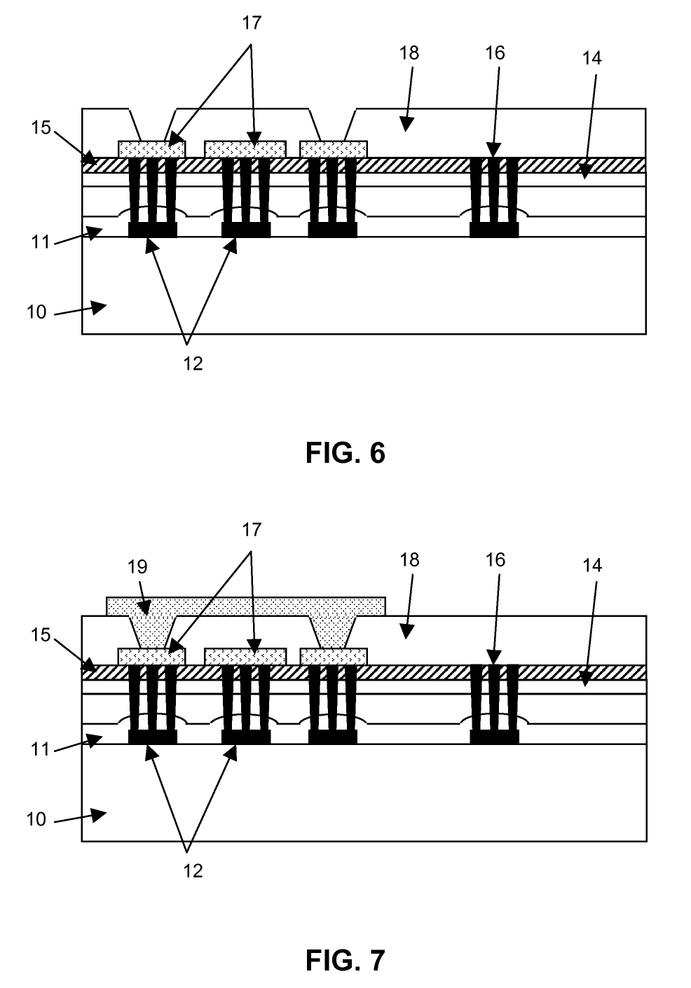

The plurality of patterned layers formed on the protection layer 15 comprises at least one sacrificial layer 18 (see FIG. 6), the sacrificial layer 18 being a layer that is at least partially removed during subsequent processing, as will described below. The sacrificial layer 18 may, for example, comprise silicon oxide, but according to other embodiments of the invention, any other suitable material known by a person skilled in the art may be used. After depositing the sacrificial layer 18, this layer may be planarized, e.g. by CMP, and may be patterned by, for example, local etching. Local etching of the sacrificial layer 18 may be performed, for example, by wet etching or by any other suitable method known by a person skilled in the art, wherein at least one of the at least one MEMS electrode 17 may act as an etch stop layer.

In a next step, illustrated in FIG. 7, a MEMS structural layer 19, e.g. a Si₁₋ₓGeₓ layer with 0.5<x<0.8 may be deposited and patterned. According to other embodiments, also other suitable materials known to a person skilled in the art may be used for forming the structural layer. The thickness of the structural layer 19 may, for example, be in the range between 50 nm and 30 μm. The structural layer 19 may, for example, be deposited by means of CVD, PECVD, PVD or evaporation. If required, for example in optical applications, e.g. for forming micro-mirrors, at least one additional layer, e.g. a thin Al layer, may be provided on the structural layer 19 (not shown in the figures).

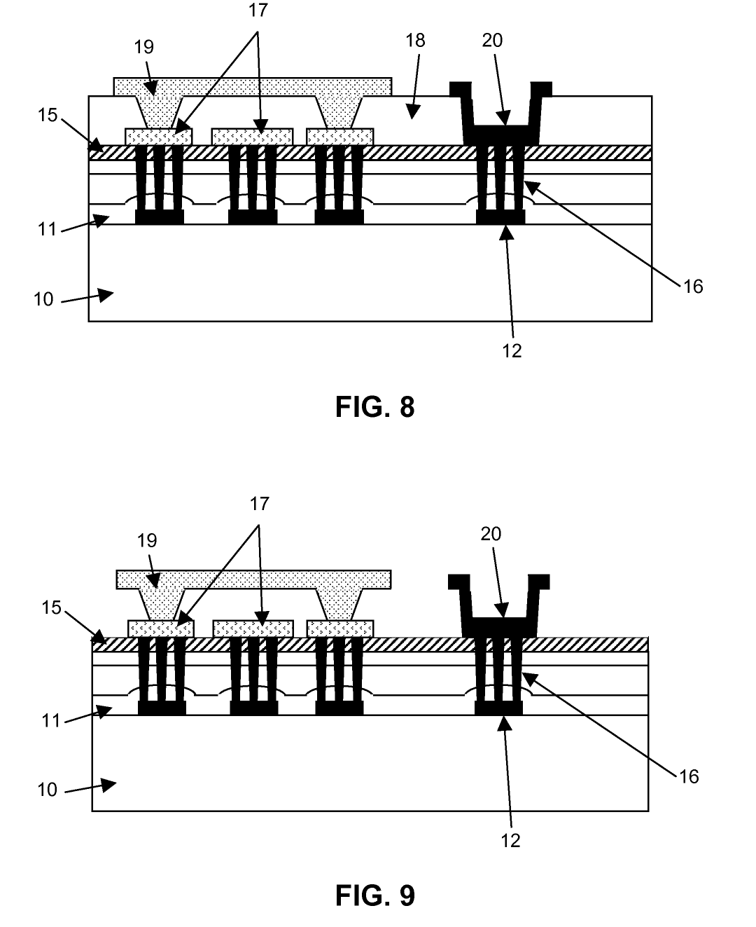

According to embodiments of the present invention, in a next step at least one opening may be provided, e.g. etched through the sacrificial layer 18, for example by means of plasma etching or wet etching. The at least one opening may, for example, be provided, e.g. etched at locations where conductive, e.g. metal plugs 16 have been formed in a previous step (described above) but are not connected to a MEMS electrode 17 (see FIG. 8). The protection layer 15 and the conductive plugs 16 may act as an etch stop layer during etching of openings in the sacrificial layer 18. After etching the at least one opening through the sacrificial layer 18, at least one bond pad 20 may be formed on top of the protection layer 15 such that the at least one bond pad is electrically connected to the conductive plugs 16. This may, for example, be done by depositing and patterning a conductive layer (see FIG. 8). In this way, an electrical connection may be made between an electrical contact pad 12 of the underlying CMOS circuitry and the outside world (bond pad 20). According to embodiments of the invention the at least one bond pad 20 may, for example, comprise Al and/or TiN and/or TaN.

As described above, to make the MEMS devices and the electrical connections as shown in FIG. 8, vias need to be provided, e.g. etched through the SiC protection layer 15 and the stack formed by the dielectric layers 11, 13, 14 and these vias may then be filled with metal plugs 16 (see FIG. 4). During etching of the layer of electrode material for forming MEMS electrodes 17, these metal plugs 16 are unprotected in the areas where bond pads 20 are to be formed. Experiments were done to investigate the influence of the etching of the layer of electrode material on the integrity of the vias and metal plugs 16. It was found that there was no significant degradation of the electrical properties of the metal plugs 16 after plasma etching of a SiGe electrode layer with a HBr based chemistry, followed by a resist strip based on O₂ ashing and wet polymer clean (3 min H₂SO₄/H₂O₂/H₂O and 2 min of HF/H₂O).

Also the effect of a via liner (TiN liner versus Ti/TiN liner for a W-via) and the via etch time on the electrical properties of the at least one bond pad 20 and its electrical connection to the underlying electrical contact pad 12 was evaluated. Experiments were done wherein the resistance of two bond pads 20 in series, connected through the vias (metal plugs 16) and the underlying metal of an electrical contact pad 12, was measured. From the experimental results shown in Table 2 it can be concluded that a Ti/TiN liner results in a lower resistance than a TiN liner, but also with a TiN liner good results may be obtained. Furthermore it can be concluded that there is a need for a sufficiently long via etch time to ensure a good electrical contact between a bond pad 20 and an electrical contact pad 12.

TABLE 2
resistance of 2 bond pads in series
(connected through vias and underlying metal)

| Via etch time | Ti/TiN liner | TiN liner |
|---|---|---|
| 160″ | — | 312-450 mΩ |
| 170″ | 250 mΩ | 312-1100 mΩ |
| 180″ | 250 mΩ | 330-400 mΩ |

After forming the at least one bond pad 20, in a next step the sacrificial layer 18 may at least partly be removed, thereby releasing the MEMS structure (see FIG. 9). This may be done by, for example, wet etching or by any other suitable method known by a person skilled in the art. According to embodiments of the invention wherein the sacrificial layer 18 comprises silicon oxide, the sacrificial layer 18 may be removed by Vapor HF etching. Advantages of using Vapor HF are stiction-free etching and a high selectivity towards metal-based films, such that there is no need for, in addition to the protection layer 15, providing protection for the at least one bond pad 20 during MEMS release. The selectivity of Vapor HF etching towards the conductive material, e.g. metal of the at least one bond pad 20 and the integrity of the at least one bond pad 20 after Vapor HF etching was experimentally checked. Therefore, Al bond pads 20 were formed, with a barrier layer underneath the Al. When a TiN barrier layer was used underneath the Al bond pad 20, the bond pads 20 were delaminating after vapor HF etching. In case of a TaN barrier layer underneath the Al bond pad 20, no attack of the underlying dielectric layers was seen and there was no significant degradation of the electrical properties of the bond pads 20 (e.g. the electrical resistance between a bond pad 20 and the underlying electrical contact pad 12) after Vapor HF etching.

It is an advantage of the present invention that MEMS devices obtained by the method according to embodiments of the present invention comprise a protection layer 15 having a defect density that is sufficiently low, e.g. less than 1/cm², for example less than 0.1/cm² or less than 0.01/cm² to avoid penetration of chemicals through the protection layer 15 during post-processing of micromachined, e.g. MEMS, devices, and that the highest temperature used during manufacturing of the micromachined devices may be lower than 450° C., for example lower than 400° C. Because of that, the CMOS electrical circuitry present on the substrate 10 on which the micromachined devices are manufactured is not damaged during manufacturing of the micromachined devices and thus shows good, reliable and proper functioning. It is a further advantage of the method according to embodiments of the present invention that a standard and cheap material can be used for the sacrificial layer 18 which can easily be planarized and which offers the possibility for a stiction-free Vapor HF release of the MEMS device, without affecting and/or destroying the CMOS electrical circuitry on the substrate 10.

It is to be understood that although preferred embodiments, specific constructions and configurations, as well as materials, have been discussed herein for devices according to the present invention, various changes or modifications in form and detail may be made without departing from the scope and spirit of this invention. Steps may be added or deleted to methods described within the scope of the present invention.

1. A method for manufacturing a micromachined device on a substrate comprising electrical circuitry, the micromachined device comprising at least one micromachined structure, the method comprising:
providing a protection layer over the substrate;
providing over the protection layer a plurality of patterned layers for forming the at least one micromachined structure, the plurality of patterned layers comprising at least one sacrificial layer; and
thereafter removing at least a portion of the sacrificial layer to release the at least one micromachined structure,
wherein the method further comprises, before providing the protection layer, annealing the substrate at a temperature higher than a highest temperature used during manufacturing of the micromachined device, the annealing preventing gas formation underneath the protection layer during subsequent manufacturing steps.

2. The method according to claim 1, wherein the method further comprises, before providing the protection layer, providing over the substrate a dielectric top layer with a number of defects less than 1/cm².

3. The method according to claim 2, wherein providing a dielectric top layer comprises:
providing over the substrate a dielectric layer;
planarizing the dielectric layer; and
annealing the substrate to reduce the number of defects in the dielectric layer to less than 1/cm².

4. The method according to claim 2, wherein providing a substantially planar dielectric top layer comprises:
providing over the substrate a first dielectric layer;
planarizing the first dielectric layer; and
providing over the first dielectric layer a second dielectric layer via a deposition technique that does not copy defects or topography from an underlying layer, thereby forming a dielectric layer comprising a number of defects less than 1/cm².

5. The method according to claim 4, wherein the deposition technique is High Density Plasma Chemical Vapor Deposition (HDPCVD).

6. The method according to claim 1, wherein providing a protection layer over the substrate is performed by providing a substantially planar protection layer.

7. The method according to claim 1, wherein annealing the substrate for preventing gas formation under the protection layer during subsequent manufacturing steps is performed at a temperature between 1° C. and 10° C. higher than the highest temperature used during manufacturing of the micromachined device.

8. The method according to claim 1, wherein process parameters of the method are such that during and after manufacturing of the micromachined device the protection layer has a number of defects less than 1/cm².

9. The method according to claim 1, wherein providing over the protection layer a plurality of patterned layers comprises depositing a layer of electrode material for forming at least one electrode.

10. The method according to claim 9, wherein the layer of lectrode material comprises Si₁₋ₓGeₓ, with 0.5<x<0.65.

11. The method according to claim 9, wherein depositing the layer of electrode material is performed by plasma enhanced Chemical Vapor Deposition or plasma assisted Chemical Vapor Deposition.

12. The method according to claim 9, wherein depositing the layer of electrode material is performed at a deposition temperature, deposition pressure, and deposition power at which stress in the layer of electrode material is a tensile stress that is lower than 100 MPa.

13. The method according to claim 9, wherein forming the at least one electrode further comprises patterning the layer of electrode material.

14. The method according to claim 13, wherein etching the
layer of electrode material is performed by a HBr based Reactive Ion Etching (RIE) process.

15. The method according to claim 1, wherein the electrical circuitry comprises at least one electrical contact pad, wherein the method further comprises, after forming the protection layer and before forming the plurality of patterned layers, providing at least one electrically conductive structure at locations corresponding to where an electrical contact pad of the electrical circuitry is located.

16. The method according to claim 15, wherein providing at least one electrically conductive structure comprises:
forming at least one via extending from the electrical contact pad through the protection layer;
filling the at least one via with an electrically conductive material; and
performing a planarization step.

17. The method according to claim 15, the method further comprising:
after forming the plurality of patterned layers and before at least partially removing the sacrificial layer, providing at least one opening through the sacrificial layer at a location where an electrically conductive structure is located; and
providing in the at least one opening an electrically conductive layer, thereby forming at least one bond pad.

18. A micromachined device manufactured according to a manufacturing method in accordance with claim 1.

19. A micromachined device over a substrate comprising electrical circuitry, the micromachined device comprising at least one micromachined structure and comprising, in between the electrical circuitry and the at least one micromachined structure, a protection layer with a defect density of less than 1/cm².

20. The micromachined device according to claim 19, further comprising, in between the electrical circuitry and the protection layer, a dielectric layer with a defect density of less than 1/cm².
